(19) United States
(12) Patent Application Publication
(10) Pub. No.: US 2026/0002529 A1
(43) Pub. Date: Jan. 1, 2026

(54) VALVE DEVICE

(71) Applicant: MIKUNI CORPORATION, Tokyo (JP)

(72) Inventors: Taiki Nakamura, Takizawa-shi (JP); Norio Takehana, Takizawa-shi (JP); Takeshi Ogi, Takizawa-shi (JP)

(21) Appl. No.: 19/220,425

(22) Filed: May 28, 2025

(30) Foreign Application Priority Data
Jul. 1, 2024 (JP) 2024-106038

(51) Int. Cl. F04B 53/10; F16K 15/14

(52) U.S. Cl. CPC F04B 53/103; F16K 15/1481

(57) ABSTRACT

A check valve for opening and closing an intake-side communication passage for fluid, includes a pump body including a partition wall in which the intake-side communication passage and a convex portion are formed, a valve body made of a flexible material, formed in a plate shape including an insertion hole, and configured to open and close the passage as being supported by the convex portion with the convex portion inserted into the insertion hole, and a push nut formed in a disk shape smaller than the valve body and including a hole into which the convex portion is inserted at a center part, and being locked to the convex portion locking the valve body to prevent the valve body from slipping off from the convex portion. An outer peripheral end part of the push nut being in contact with the valve body being formed in a curved surface shape.

### CROSS-REFERENCE TO RELATED APPLICATION

The present application claims priority of Japanese patent application Serial No. 2024-106038, filed July 1, 2024, the content of which is hereby incorporated by reference in its entirety.

### BACKGROUND OF THE INVENTION

### FIELD OF THE INVENTION

The present invention relates to a valve device opening and closing a passage for fluid.

### DESCRIPTION OF THE RELATED ART

Various kinds of valve devices that open and close a passage for fluid, such as a check valve used in a fuel pump of an engine and the like, are known.

For example, a check valve of a fuel pump disclosed in Japanese Patent Laid-Open No. 2019-78288 is provided at an opening of a communication passage that makes two chambers communicate with each other and through which fuel passes, and includes a disk-shaped flexible material such as a resin membrane as a valve body. A center part of the valve body is supported, and an outer peripheral portion of the valve body is swingable. Further, the valve body has a structure in which a plurality of openings arranged concentrically around the supported portion are opened and closed. A valve seat protruding toward the valve body is provided around the openings. When pressure on a side of the valve body opposite to the communication passage exceeds pressure on the communication passage side, the valve body and the valve seat contact each other to block the openings. In contrast, when the pressure of the valve body on the communication passage side exceeds the pressure on the side opposite to the communication passage, the valve body and the valve seat are separated from each other to open the openings.

In Japanese Patent Laid-Open No. 2019-78288 described above, grommets are inserted into and fixed to holes provided in a pump body, to support the valve body. Therefore, to prevent the grommets from slipping off from the holes of the pump body, it is necessary to provide, for example, barbs at front ends of the grommets. This makes it difficult to assemble the grommets into the pump body, and increases assembling man-hours.

Alternatively, a structure in which a protrusion is provided on the pump body, a front end of the protrusion is swaged after the protrusion supports the valve body, thereby supporting the valve body to the pump body is considered. However, in this structure, the assembling man-hours are increased because swaging is performed.

In addition, the valve body is frequently moved by opening/closing operation. For this reason, securement of durability at a contact part of the supported portion is required.

The present invention is made in consideration of such issues, and is directed to a valve device that facilitates attachment of a valve body and is improved in durability.

### SUMMARY OF THE INVENTION

A valve device according to disclosed embodiments of the present invention is a valve device opening and closing a passage for fluid, and includes: a housing including a wall member in which the passage and a convex portion are formed; a valve body made of a flexible material, formed in a plate shape including a first hole, and configured to open and close the passage as being supported by the convex portion with the convex portion inserted into the first hole; and a push nut formed in a disk shape smaller than the valve body and including a second hole into which the convex portion is inserted at a center part, and being locked to the convex portion to prevent the valve body from slipping off from the convex portion. An outer peripheral end part of the push nut in contact with the valve body being formed in a curved surface shape.

In the valve device according to disclosed embodiments of the present invention, the convex portion is inserted into the first hole of the valve body to cause the convex portion of the housing to support the valve body, and the push nut is locked to the convex portion. This makes it possible to easily assemble the valve body to the housing.

Further, the outer peripheral end part of the push nut contacting the valve body is formed in a curved surface shape. Therefore, even when the outer peripheral end part of the push nut contacts the valve body during opening/closing of the valve body, the valve body is hardly damaged, which makes it possible to improve durability of the valve body, namely, durability of the valve device.

The present summary is provided only by way of example and not limitation. Other aspects of the present invention will be appreciated in view of the entirety of the present disclosure, including the entire text, claims, and accompanying figures.

### BRIEF DESCRIPTION OF THE DRAWINGS

FIG. 1 is an appearance view of a fuel pump adopting a valve device according to the present invention;

FIG. 2 is a vertical cross-sectional view illustrating a structure of the fuel pump adopting the valve device according to the present invention;

FIG. 3 is a vertical cross-sectional view illustrating a fuel intake state of the fuel pump according to the present embodiment;

FIG. 4 is a vertical cross-sectional view illustrating a fuel discharge state of the fuel pump according to the present embodiment;

FIG. 5 is a top view of a pump body including a first check valve and a second check valve according to the present embodiment;

FIG. 6 is an assembly diagram of the first check valve according to the present embodiment;

FIG. 7 is a perspective view illustrating appearance of a push nut;

FIG. 8 is a vertical cross-sectional view illustrating a cross-sectional shape of the first check valve when the valve is closed; and

FIG. 9 is a vertical cross-sectional view illustrating the cross-sectional shape of the first check valve when the valve is opened.

While the above-identified figures set forth one or more embodiments of the present invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features, steps, and/or components not specifically shown in the drawings.

### DETAILED DESCRIPTION OF THE INVENTION

An embodiment of the present invention is described below with reference to drawings.

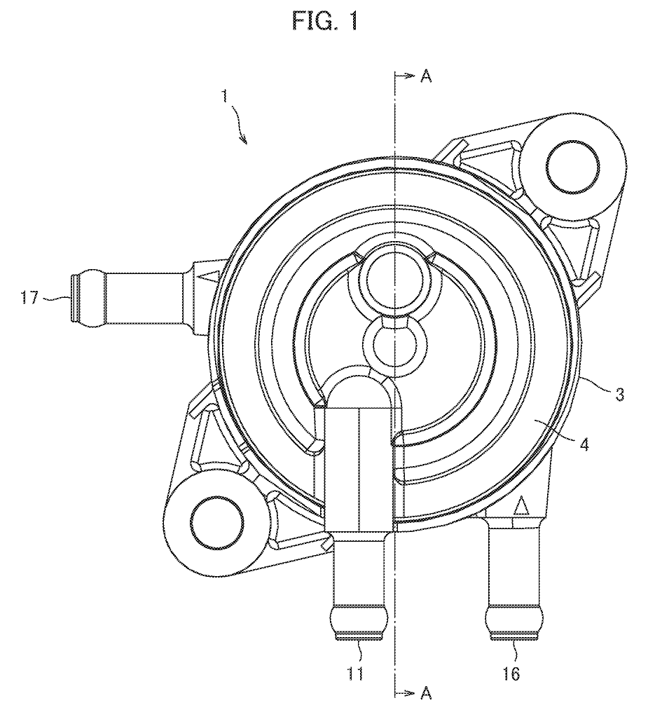

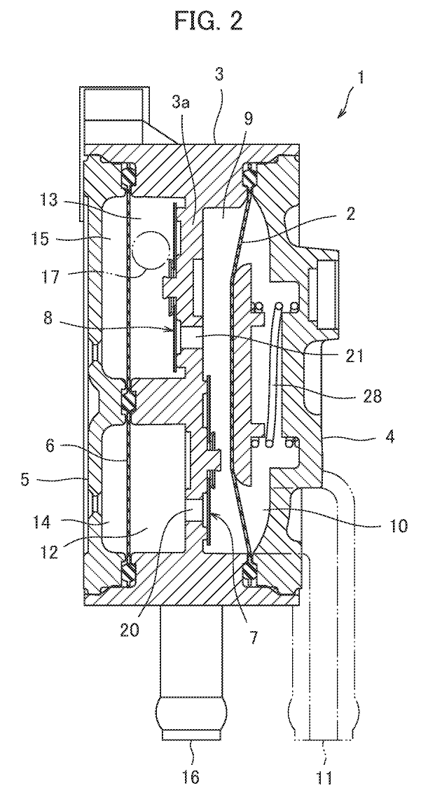

FIG. 1 is an appearance view of a fuel pump 1 adopting a valve device according to the present invention. FIG. 2 is a vertical cross-sectional view illustrating a structure of the fuel pump. FIG. 2 illustrates a cross-section taken along line A-A illustrated in FIG. 1.

As illustrated in FIGS. 1 and 2, the fuel pump 1 according to the present embodiment is a diaphragm fuel pump including a diaphragm 2, and supplies fuel from a fuel tank to a fuel supply device of an engine.

The fuel pump 1 includes a pump body 3, a bottom body 4, a cover 5, the diaphragm 2, a membrane 6, a first check valve 7, and a second check valve 8. The first check valve 7 and the second check valve 8 each correspond to the valve device according to the present invention. The pump body 3, the bottom body 4, and the cover 5 correspond to a housing according to the present invention.

The pump body 3, the bottom body 4, and the cover 5 are made of, for example, a resin. The pump body 3 internally includes a partition wall 3a (wall member) and is formed in a substantially cylindrical shape in which both side ends are opened. The bottom body 4 is fixed to one side end of the pump body 3 to seal the one side end of the pump body 3. The cover 5 is fixed to the other side end of the pump body 3 to seal the other side end of the pump body 3.

The diaphragm 2 and the membrane 6 are made of, for example, NBR rubber, and are each formed in a thin disk shape. The diaphragm 2 is held by the pump body 3 and the bottom body 4. The membrane 6 is held by the pump body 3 and the cover 5.

A pump chamber 9 is provided between the diaphragm 2 and the partition wall 3a of the pump body 3. A pulse chamber 10 is provided between the diaphragm 2 and the bottom body 4. In other words, the diaphragm 2 defines the pump chamber 9 and the pulse chamber 10. A pulse introduction port 11 for introducing pressure into the pulse chamber 10 is provided in the bottom body 4, and pulsing pressure such as intake air is introduced from an intake manifold or a crank chamber of an unillustrated engine into the pulse chamber 10 through the pulse introduction port 11.

A spring 28 that urges the diaphragm 2 is provided inside the pulse chamber 10. The spring 28 urges the diaphragm 2 toward the pump chamber 9 relative to the bottom body 4.

A fuel intake chamber 12 and a fuel discharge chamber 13 are provided between the membrane 6 and the partition wall 3a of the pump body 3. An intake-side damper chamber 14 that faces the fuel intake chamber 12 with the membrane 6 in between and a discharge-side damper chamber 15 that faces the fuel discharge chamber 13 with the membrane 6 in between are provided between the membrane 6 and the cover 5. In other words, the membrane 6 defines the fuel intake chamber 12 and the intake-side damper chamber 14, and defines the fuel discharge chamber 13 and the discharge-side damper chamber 15.

The pump body 3 includes an intake port 16 communicating with the fuel intake chamber 12, and a discharge port 17 communicating with the fuel discharge chamber 13. The intake port 16 is connected to the unillustrated fuel tank, and the discharge port 17 is connected to a fuel injection device of the engine or the like.

The partition wall 3a of the pump body 3 includes intake-side communication passages 20 connecting the fuel intake chamber 12 and the pump chamber 9, and discharge-side communication passages 21 connecting the pump chamber 9 and the fuel discharge chamber 13. The intake-side communication passages 20 and the discharge-side communication passages 21 correspond to a passage according to the present invention.

The first check valve 7 is provided on the partition wall 3a of the pump body 3, and has a function of opening and closing the intake-side communication passages 20. The first check valve 7 has a function of allowing fuel to pass only from the fuel intake chamber 12 to the pump chamber 9.

The second check valve 8 is provided on the partition wall 3a of the pump body 3, and has a function of opening and closing the discharge-side communication passages 21. The second check valve 8 has a function of allowing fuel to pass only from the pump chamber 9 to the fuel discharge chamber 13.

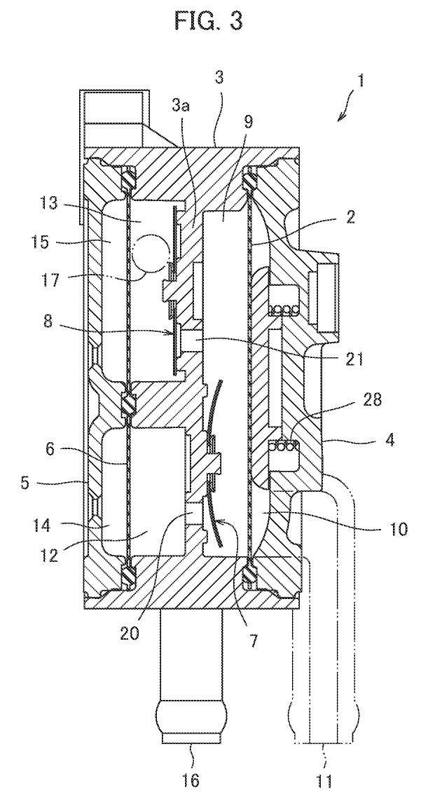

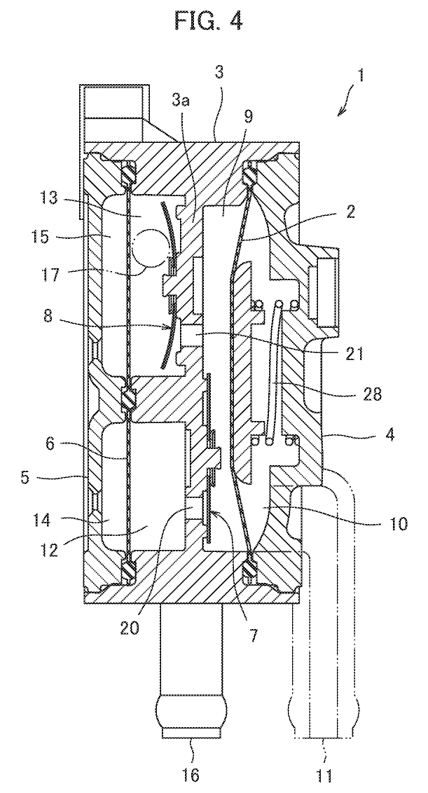

FIG. 3 is a vertical cross-sectional view illustrating a fuel intake state of the fuel pump 1. FIG. 4 is a vertical cross-sectional view illustrating a fuel discharge state of the fuel pump 1.

In the fuel pump 1 configured as described above, when the engine operates, the pulsing pressure is introduced into the pulse chamber 10, and the pressure inside the pulse chamber 10 becomes negative, the diaphragm 2 moves toward the bottom body 4, namely, rightward in FIG. 3 against urging by the spring 28, as illustrated in FIG. 3. As a result, the pressure inside the pump chamber 9 becomes negative, the first check valve 7 is opened and the second check valve 8 is closed, and the fuel moves from the fuel intake chamber 12 to the pump chamber 9.

When the pressure inside the pulse chamber 10 becomes positive, the diaphragm 2 moves toward a side opposite to the bottom body 4, namely, leftward in FIG. 4, as illustrated in FIG. 4. As a result, the pressure inside the pump chamber 9 becomes positive, the first check valve 7 is closed and the second check valve 8 is opened, and the fuel moves from the pump chamber 9 to the fuel discharge chamber 13. The diaphragm 2 is urged toward the pump chamber 9 by the spring 28. Thus, when the pressure inside the pulse chamber 10 is changed from negative to positive, movement of the diaphragm 2 is promoted, and movement of the fuel from the pump chamber 9 to the fuel discharge chamber 13 is promoted.

When the pulsing pressure that repeats positive pressure and negative pressure is supplied from the engine into the pulse chamber 10, movement of the diaphragm 2 illustrated in FIG. 3 and FIG. 4 is repeated, the fuel is taken in from the intake port 16, and the fuel is discharged from the discharge port 17.

The membrane 6 moderates rapid variation of the pressure in the fuel intake chamber 12 and the fuel discharge chamber 13. Thus, the fuel is stably discharged from the fuel discharge chamber 13 of the fuel pump 1.

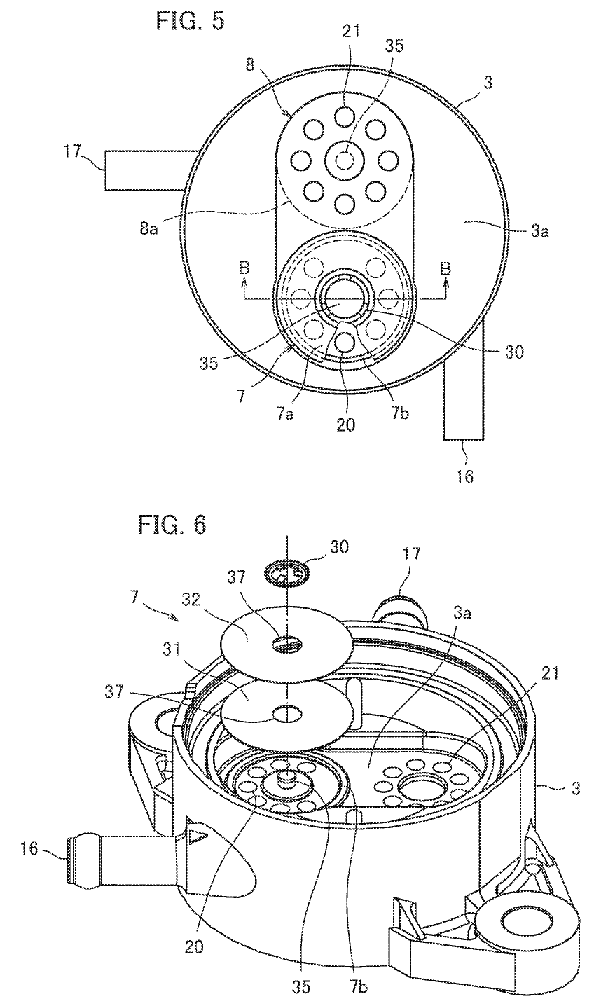

Next, details of the first check valve 7 are described with reference to FIG. 5 to FIG. 9.

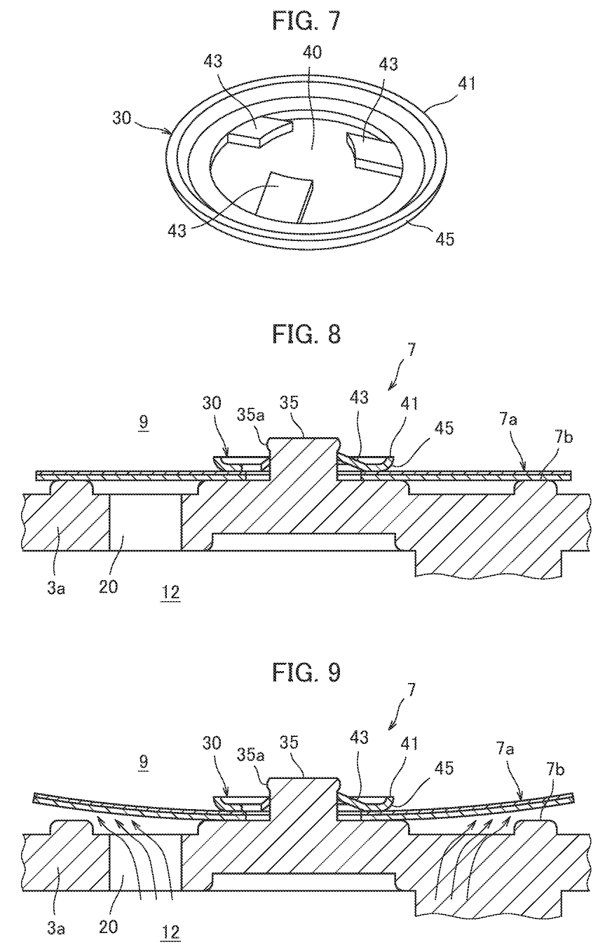

FIG. 5 is a top view of the pump body 3 including the first check valve 7 and the second check valve 8. FIG. 6 is an assembly diagram of the first check valve 7. FIG. 7 is a perspective view illustrating a shape of a push nut 30. FIG. 8 is a vertical cross-sectional view illustrating a cross-sectional shape of the first check valve 7 when the valve is closed. FIG. 9 is a vertical cross-sectional view illustrating a cross-sectional shape of the first check valve 7 when the valve is opened. Note that FIG. 5 is a diagram of the first check valve 7 and the second check valve 8 provided in the pump body 3 as viewed from the pump chamber 9 side. FIGS. 8 and 9 are cross-sectional views taken along line B-B illustrated in FIG. 5. Arrows illustrated in FIG. 9 indicate moving directions of the fuel.

As illustrated in FIGS. 5 and 6, the first check valve 7 provided on the partition wall 3a includes a valve body 7a that has flexibility and is formed in a circular thin plate shape. The valve body 7a is configured by superimposing a first valve body 31 and a second valve body 32. The first valve body 31 is made of NBR and formed in a thin plate shape. The second valve body 32 is made of PET and formed in a thin plate shape.

As illustrated in FIGS. 5, 6, 8, and 9, the partition wall 3a includes convex portions 35 for supporting the first valve body 31 and the second valve body 32. Each convex portion 35 has a columnar shape protruding toward the pump chamber 9. The intake-side communication passages 20 provided in the partition wall 3a are provided concentrically around the corresponding convex portion 35 at intervals in a circumferential direction. On a wall surface of the partition wall 3a on the pump chamber 9 side, a valve seat 7b that protrudes in an annular shape and has a top surface serving as a seat surface is provided on an outside of the intake-side communication passages 20. All openings of the intake-side communication passages 20 and the valve seat 7b are covered with the valve body 7a.

A circular insertion hole 37 into which the convex portion 35 is inserted is provided at a center part of each of the first valve body 31 and the second valve body 32. The convex portion 35 is inserted into the insertion hole 37 of the first valve body 31 and the insertion hole 37 of the second valve body 32 in order from the partition wall 3a side. Thereafter, the push nut 30 is fitted and fixed to the convex portion 35. As a result, the first valve body 31 and the second valve body 32 are sandwiched and supported between the partition wall 3a and the push nut 30.

The push nut 30 is made of, for example, SUS.

As illustrated in FIG. 7, the push nut 30 includes a hole 40 larger than the convex portion 35 at a center part of its disk shape, and the convex portion 35 is inserted into the hole 40. Three claws 43 that extend from an inside part of an outer peripheral portion 41 having an annular shape toward the center part are provided. The claws 43 each have a width in the circumferential direction of about several mm, and are disposed on the outer peripheral portion 41 at equal intervals in the circumferential direction. Radial inside end surfaces of the claws 43 contact an outer peripheral surface of the convex portion 35 and are locked to the convex portion 35.

The claws 43 of the push nut 30 are inclined toward one side surface by about several degrees. Further, in the outer peripheral portion 41 of the push nut 30, an outer peripheral end part 45 on the other side surface side is chamfered in an arc shape or bent over the entire circumference. In other words, a corner at the outer peripheral end part of the push nut 30 on the other side surface side is rounded in an arc shape.

As illustrated in FIG. 6, the push nut 30 is fitted to the convex portion 35 from the other side surface side, in order to support the first valve body 31 and the second valve body 32 into which the convex portion 35 has been inserted.

As illustrated in FIGS. 8 and 9, a protrusion 35a slightly protruding radially outward is provided at a front end of the convex portion 35. The protrusion 35a may be formed by, for example, causing the front end of the convex portion 35 to protrude radially outward in a part of the circumferential direction, or may be formed by slightly making an outer diameter at the front end of the convex portion 35 large over the entire circumference. When the convex portion 35 is inserted into the hole 40 of the push nut 30 after the first valve body 31 and the second valve body 32 are attached to the convex portion 35, the claws 43 contact the front end of the convex portion 35 and are bent toward the one side surface. After the front end of the convex portion 35 passes through the claws 43, bending of the claws 43 is eliminated, and the claws 43 are locked to the protrusion 35a of the convex portion 35. As a result, the push nut 30 presses and supports the first valve body 31 and the second valve body 32, which prevents the valve body 7a (first valve body 31 and second valve body 32) from slipping off from the convex portion 35. Note that, in a case where the protrusion 35a is formed by causing the front end of the convex portion 35 to protrude radially outward in a part of the circumferential direction, a width and an interval of the protrusion 35a in the circumferential direction are set such that at least a part of the claws 43 are locked to the protrusion 35a. Further, even if the protrusion 35a is not provided, a function of preventing the valve body 7a from slipping off from the convex portion 35 can be obtained by causing the claws 43 to bite into the convex portion 35 to lock the push nut 30 to the convex portion 35. However, providing the protrusion 35a makes the push nut 30 harder to be detached.

The second check valve 8 also includes the convex portion 35 and the valve body 8a having shapes respectively similar to the convex portion 35 and the valve body 7a of the first check valve 7. As with the valve body 7a, the valve body 8a is supported by the convex portion 35, and is prevented from slipping off from the convex portion 35 by the push nut 30. Further, as with the intake-side communication passages 20, the discharge-side communication passages 21 are provided concentrically around the convex portion 35 at intervals in the circumferential direction. However, the second check valve 8 is different from the first check valve 7 in that the valve body 8a and the valve seat are not provided on the pump chamber 9 side, and are provided on the fuel discharge chamber 13 side opposite to the pump chamber 9.

As illustrated in FIG. 8, in a case where the pressure in the pump chamber 9 is higher than the pressure in the fuel intake chamber 12, the outer peripheral portion of the valve body 7a of the first check valve 7 abuts on the valve seat 7b of the partition wall 3a. Thus, all openings of the intake-side communication passages 20 are closed by the valve body 7a, and inflow of the fuel from the pump chamber 9 to the fuel intake chamber 12 is blocked.

As illustrated in FIG. 9, in a case where the pressure in the fuel intake chamber 12 is higher than the pressure in the pump chamber 9, the outer peripheral portion of the valve body 7a is bent toward the pump chamber 9. Thus, the outer peripheral portion of the valve body 7a is separated from the valve seat 7b. Accordingly, the fuel in the fuel intake chamber 12 flows into the pump chamber 9 through the intake-side communication passages 20 and a space between the valve body 7a and he valve seat 7b.

As described above, the first check valve 7 provided in the fuel pump 1 according to the present embodiment is the valve device opening and closing, by the valve body 7a, the intake-side communication passages 20 provided in the partition wall 3a. The partition wall 3a includes the convex portion 35 at a position near the intake-side communication passages 20. As the valve body 7a, the first valve body 31 made of rubber and the second valve body 32 made of a PET material are locked to the convex portion 35. The push nut 30 is also locked to the convex portion 35, thereby preventing the valve body 7a from slipping off from the convex portion 35.

In the above-described manner, by fitting the valve body 7a and the push nut 30 to the convex portion 35, the valve body 7a can be easily locked to the convex portion 35, and the assembling man-hours of the first check valve 7 can be reduced.

Although the push nut 30 has an annular plate shape, the outer peripheral end part of the push nut 30 contacting the valve body 7a has a curved surface. The valve body 7a is opened to be bent toward the push nut 30, and contacts the outer peripheral end part of the push nut 30. Accordingly, by forming the outer peripheral end part of the push nut 30 in a curved surface shape, the contacting valve body 7a can be protected, and durability of the valve body 7a can be secured.

The push nut 30 includes the outer peripheral portion 41 and the claws 43. The outer peripheral portion 41 has an annular plate shape and includes, at the center part, the hole 40 larger than the convex portion 35. The claws 43 extend from the inside surface of the outer peripheral portion 41 toward the center part. Front ends of the claws 43 contact the outer peripheral surface of the convex portion 35 and are locked to the convex portion 35. Thus, the push nut 30 can be configured with a simple and compact configuration, and can be easily locked to the convex portion 35.

In particular, it is possible to form the push nut 30 in a thin plate shape, and to suppress a protruding length of the convex portion 35 toward the pump chamber 9. Therefore, it is unnecessary to increase a width of the pump chamber 9 in order to prevent the convex portion 35 from contacting the diaphragm 2 disposed inside the pump chamber 9, which makes it possible to configure the compact fuel pump 1.

The claws 43 extend to be inclined in an axial direction while extending from the inside surface of the outer peripheral portion 41 to the center part. When the convex portion 35 is inserted into the hole 40 of the push nut 30 in a direction in which the claws 43 are inclined toward the protruding direction of the convex portion 35, the front ends of the claws 43 contact the front end of the convex portion 35, and are easily bent. This causes the convex portion 35 to be inserted into the hole 40 to lock the push nut 30. In addition, the push nut 30 locked to the convex portion 35 hardly slips off.

Since the protrusion 35a protruding radially outward is provided at the front end of the convex portion 35, the claws 43 of the push nut 30 can be surely locked to a neck part of the protrusion 35a.

The protrusion 35a protrudes radially outward over the entire circumference of the convex portion 35. Thus, even when the push nut 30 is directed in any circumferential direction relative to the convex portion 35, the claws 43 of the push nut 30 can be locked to the protrusion 35a.

Note that the three claws 43 are provided on the outer peripheral portion 41 of the push nut 30 at equal intervals in the circumferential direction. This makes it possible to suppress the number of claws 43 and to suppress a manufacturing cost of the push nut 30 while the slip-off prevention function is sufficiently secured by the claws 43. The number of claws 43 may be a plurality other than three. Only one claw 43 may be provided, but a plurality of claws 43 are preferably provided in terms of locking property of the push nut 30.

The description of the embodiment is finished here, but an aspect of the present invention is not limited to the above-described embodiment. For example, although the configuration of the first check valve 7 is described in the above-described embodiment, the second check valve 8 may also be configured such that the valve body 8a is prevented from slipping off from the convex portion 35 by the push nut 30.

In the present embodiment, the present invention is applied to the first check valve 7 controlling a flow of the fuel; however, the present invention is applicable to a check valve controlling a flow of fluid other than the fuel.

In addition, the present invention may be applied to a check valve used in an apparatus other than the fuel pump. The present invention is widely applicable to even a valve device having a structure in which the valve is opened by bringing a valve body having flexibility into contact with a valve seat, other than the check valve.

### Reference Signs List

1 Fuel pump

3 Pump body (housing)

3a Partition wall (wall member)

4 Bottom body (housing)

5 Cover (housing)

7 First check valve (valve device)

7a Valve body

8 Second check valve (valve device)

20 Intake-side communication passage (passage)

21 Discharge-side communication passage (passage)

30 Push nut

35 Convex portion

35a Protrusion

37 Insertion hole (first hole)

40 Hole (second hole)

41 Outer peripheral portion (main body portion)

43 Claw

45 Outer peripheral end part

Although the present invention has been described with reference to preferred embodiments, workers skilled in the art will recognize that changes may be made in form and detail without departing from the spirit and scope of the invention.

What is claimed is:

1. A valve device opening and closing a passage for fluid, comprising:a housing including a wall member in which the passage and a convex portion are formed;a valve body made of a flexible material, formed in a plate shape including a first hole, andconfigured to open and close the passage as being supported by the convex portion with the convex portion inserted into the first hole; and
a push nut formed in a disk shape smaller than the valve body and including a second hole into which the convex portion is inserted at a center part, and being locked to the convex portion to prevent the valve body from slipping off from the convex portion,
an outer peripheral end part of the push nut in contact with the valve body being formed in a curved surface shape.

2. The valve device according to claim 1, wherein the valve body includes a first valve body made of rubber, and a second valve body made of a PET material,
an outer peripheral portion of the push nut is formed in a curved surface shape and abuts on the second valve body, and
the first valve body abuts on a valve seat provided on the housing.

3. The valve device according to claim 2, wherein the valve body is configured by superimposing the first valve body and the second valve body.

4. The valve device according to claim 2, wherein the push nut includes a main body portion having an annular plate shape and including, at a center part, the second hole larger than the convex portion, and a claw inclined in an axial direction and extending from an inside surface of the main body portion toward the center part, and
a front end of the claw is in contact with an outer peripheral surface of the convex portion and is locked to the convex portion.

5. The valve device according to claim 4, wherein the convex portion incudes, at a front end, a protrusion protruding radially outward, andthe claw of the push nut is locked to the protrusion.

6. The valve device according to claim 5, wherein the protrusion protrudes radially outward over an entire circumference of the convex portion.

7. The valve device according to claim 4, wherein a plurality of the claws are provided at equal intervals in a circumferential direction of the main body portion.

8. The valve device according to claim 1, wherein the valve device is provided in a fuel pump, andthe fluid is fuel.
